(19) United States
(12) Patent Application Publication
(10) Pub. No.: US 2025/0270818 A1
(43) Pub. Date: Aug. 28, 2025

(54) COVER CLIPS FOR SUB-GIRTS IN EXTERIOR WALL SYSTEM ASSEMBLIES

(71) Applicant: Sto Corp., Atlanta, GA (US)

(72) Inventor: David J. SIMONSEN, Redding, CA (US)

(73) Assignee: Sto Corp., Atlanta, GA (US)

(21) Appl. No.: 19/065,005

(22) Filed: Feb. 27, 2025

Related U.S. Application Data
(60) Provisional application No. 63/558,644, filed on Feb. 27, 2024.

(51) Int. Cl. E04F 13/08; E04B 1/94

(52) U.S. Cl. CPC E04F 13/0803; E04B 1/945; E04F 2290/045

(57) ABSTRACT

Embodiments of the invention relate to clips for mounting on a support rail or sub-girt (such as an FRP sub-girt) and wall system assemblies that include such clips. An embodiment of the clip includes a first arm portion, a second arm portion, a connecting ledge connecting the first arm portion to the second arm portion, and a retaining arm portion connected to the second arm portion such that a retention cavity is defined between the retaining arm portion and the second arm portion. The clip may be mounted on a sub-girt at a mounting location such that a flange of the sub-girt resides in the retention cavity of the clip and such that the connecting ledge of the clip seats on a support surface of the sub-girt. When so mounted, the second arm portion of the clip covers the entirety of the outer surface of the flange and the retaining arm portion of the clip covers at least a portion of the inner surface of the flange such that both the second arm portion and the retaining arm portion are available-along with the sub-girt flange-to receive a fastener. When so mounted, the first arm portion of the clip is available to help retain an insulation layer in a wall system assembly.

### CROSS REFERENCE TO RELATED APPLICATIONS

This application claims priority to U.S. Provisional Patent Application Ser. No. 63/558,644 entitled “Combustion Cover Insulation Clip”, filed Feb. 27, 2024, the entirety of which is herein incorporated by reference.

### TECHNICAL FIELD

The present disclosure relates generally to exterior wall system assemblies and, more specifically, to clips for sub-girts used in exterior wall system assemblies.

### BACKGROUND

Exterior wall system assemblies are often made of multiple components that impart various desired performance characteristics to the wall assemblies. One such component used in such wall assemblies are sub-girts, which are often provided in horizontal rows and/or vertical columns and are designed to support one or more components within the assembly, such as the insulation layer and/or exterior cladding.

Some sub-girts used today are made of fiber reinforced polymer (FRP). While FRP sub-girts are extremely beneficial from a thermal performance standpoint, they are combustible (regardless of the fiber type used to make them) and thus promote flame propagation. Moreover, FRP sub-girts are known to have problems with fastener pull-out and/or pull-over because the FRP material is often not strong enough to support components within the assembly (such as the cladding). These problems are only exacerbated if the installer makes multiple mistakes in the same fastening location such that a fastener may no longer be securely retained within the sub-girt and the sub-girt instead must be replaced. Furthermore, most FRP sub-girts are not designed to structurally support the insulation layer by themselves, and for this reason they require separate insulation mounting components to support the insulation within the installation. Such mounting components are often non-structural and puncture the insulation and/or puncture or adhere to the weather barrier layer, rendering the assembly vulnerable to water ingress and resultant mold, rust, and/or rot within the assembly.

### SUMMARY

Embodiments are directed to clips for mounting on support rails or sub-girts, such as FRP sub-girts, used to mount components of wall system assemblies, as well as wall system assemblies that use such clips. An embodiment of the clip includes a first arm portion, a second arm portion, a connecting ledge connecting the first arm portion to the second arm portion, and a retaining arm portion connected to the second arm portion such that a retention cavity is defined between the retaining arm portion and the second arm portion. The clip may be mounted on a sub-girt at a mounting location such that a flange of the sub-girt resides in the retention cavity of the clip and such that the connecting ledge of the clip seats on a support surface of the sub-girt. When so mounted, the second arm portion of the clip covers the entirety of the outer surface of the flange and the retaining arm portion of the clip covers at least a portion of the inner surface of the flange such that both the second arm portion and the retaining arm portion are available-along with the sub-girt flange-to receive a fastener. When so mounted, the first arm portion of the clip is available to help retain an insulation layer in a wall system assembly.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a side elevation view of a first embodiment of a clip profile.

FIG. 2 is a front perspective view of a clip for use in combination with a sub-girt in an exterior wall system assembly, wherein the clip has the clip profile of FIG. 1.

FIG. 3 is a rear perspective view of the clip of FIG. 2.

FIG. 4 is a front perspective view of another clip for use in combination with a sub-girt in an exterior wall system assembly, wherein the clip has the clip profile of FIG. 1.

FIG. 5 is a perspective view of the clip of FIG. 2 mounted on a sub-girt.

FIG. 6 is a perspective view of two clips of FIG. 4 mounted on a sub-girt.

FIG. 7 is a side elevation view of the clip(s) and the sub-girt of FIGS. 5 and 6.

FIG. 8 is a cross-sectional view of an exterior wall system assembly in which the clip(s) and the sub-girt shown of FIG. 7 are installed.

FIG. 9 is a side elevation view of a second embodiment of a clip profile.

FIG. 10 is a front perspective view of a clip for use in combination with a sub-girt in an exterior wall system assembly, wherein the clip has the clip profile of FIG. 9.

FIG. 11 is a rear perspective view of the clip of FIG. 10.

FIG. 12 is a perspective view of the clip of FIG. 10 mounted on a sub-girt.

FIG. 13 is a cross-sectional view of an exterior wall system assembly in which the clip and the sub-girt shown of FIG. 12 are installed.

FIG. 14 is a schematic of an assembly showing exemplary placement of the clips disclosed herein within an installation.

FIG. 15 is a front elevation view of an embodiment of a clip having a drainage hole and mounted on a sub-girt in an exterior wall system assembly.

### DETAILED DESCRIPTION

The present disclosure encompasses clips that can be mounted on sub-girts for use in exterior wall system assemblies, such as rainscreen type wall system assemblies. The clips of the present disclosure can be used to secure insulation and/or mount cladding and/or other wall components to a structure within an exterior wall system assembly. The clips of the present disclosure can be formed of a fire-resistant material and combat combustion when used in combination with a fiber reinforced polymer sub-girt. The combination of a clip of the present disclosure with a sub-girt can provide a multi-layer substrate to receive fasteners, thereby enhancing engagement and retention of the fasteners within the sub-girt and thus the structural integrity of the installation.

As used herein, the term “sub-girt” refers to a substructural component that can be used within an exterior wall system assembly as a platform on which to mount another component, such as cladding, within the assembly. As used herein, the singular forms of “a,” “an,” and “the” encompass the plural forms thereof unless otherwise indicated. As used herein, the phrase “at least one” includes all numbers of one and greater. As used herein, the term “and/or” refers to one or all of the listed elements or a combination of any two or more of the listed elements. As used herein, the term “plurality” refers to a number greater than one. As used herein, the term “oblique” refers to an alignment of one surface or structure that is non-parallel and non-perpendicular to another surface or structure. As used herein, the term “integrally formed” refers to the construction of two or more components from a single, unitary body or structure.

As used herein, the term “fire-resistant” refers to a material that is considered “non-combustible” and/or a “fire blocking” material and/or otherwise tends to resist combustion when exposed to fire or a source of ignition.

As used herein, the term “water-resistant” refers to a material or object that tends to inhibit or to prevent water migrating therethrough or penetrating therein under atmospheric conditions.

While multiple embodiments of the clip are disclosed herein, all are formed of a resilient material considered fire-resistant, such as, but not limited to, steel, stainless steel, zinc-aluminum-magnesium coated steel, aluminum, or other metal or alloy. In some embodiments, the clips are formed from 14-gauge to 18-gauge metal. While the clips may be formed of multiple components attached together, in some embodiments the clips are integrally formed from a single piece of material that is bent or otherwise shaped as desired (such as via a roll-forming process). In this way, a spring-like property is imparted to the clip and material and labor costs are reduced. The clips may be manufactured on a roll-former from slit-to-width steel strips and having an integrated punch process for creating apertures and cut-outs. The clips may also be made from a flat steel sheet with flat patterns made on a turret press and then formed on a brake press or folder. However, the clips disclosed herein are not limited to any particular manufacturing process.

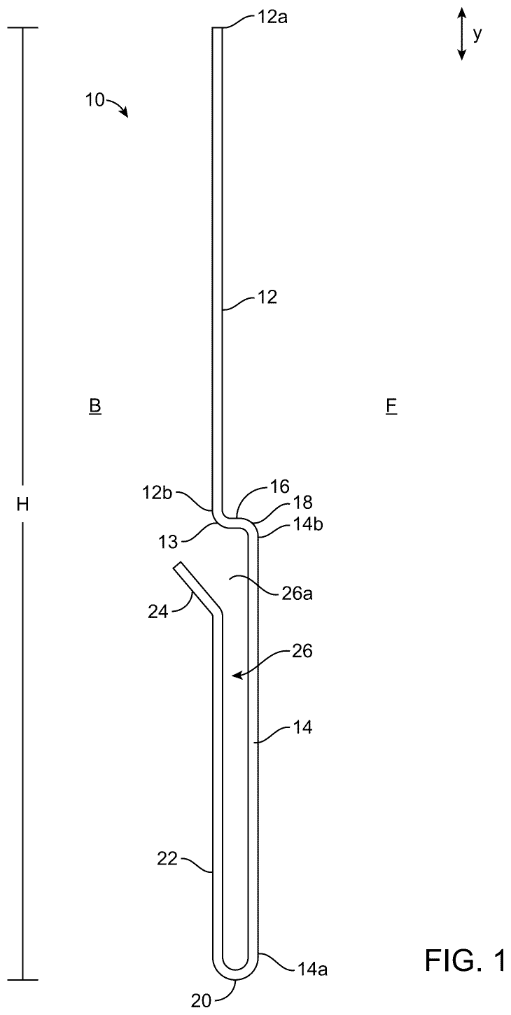

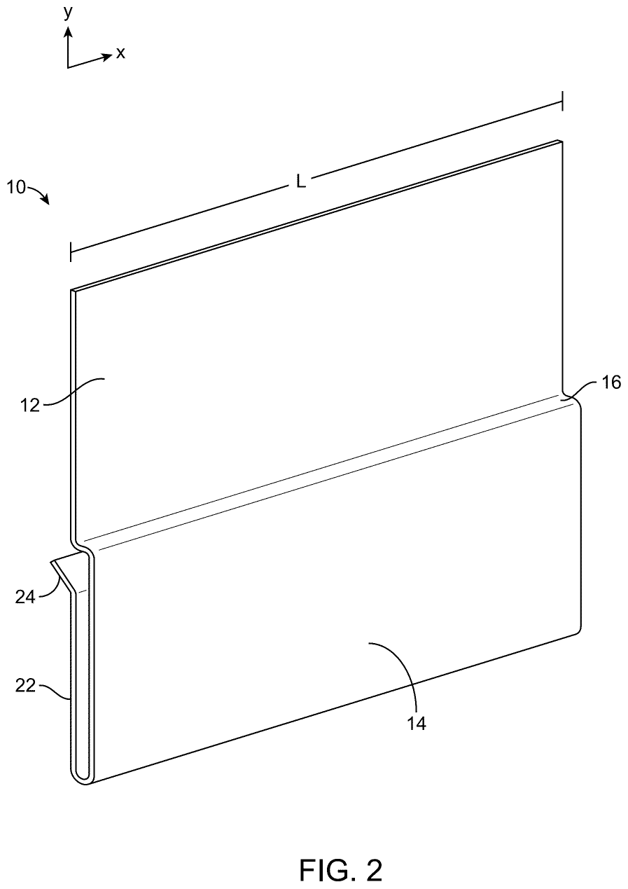

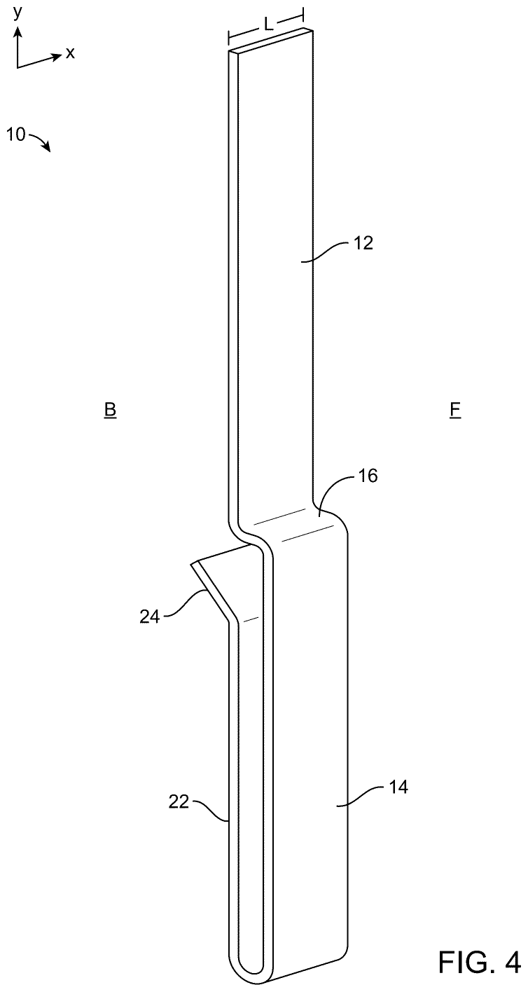

FIG. 1 illustrates the profile of a first embodiment of a clip 10 in isolation. The clip 10 has a frontside F, a backside B, a length L measured along axis x, and a height H measured along axis y. Clip 10 may be provided in different lengths L. For example, FIG. 2 illustrates clip 10 having length L that is longer than the length L of clip 10 illustrated in FIG. 4. In some embodiments, the profile of clip 10 is consistent along the entire length L of the clip 10 but such may not always be the case.

Regardless of its length L, clip 10 includes a first arm portion 12 and a second arm portion 14 laterally offset from the first arm portion 12 by a connecting ledge 16. In some embodiments, one or both of the first arm portion 12 and the second arm portion 14 extend in a plane substantially parallel to axis y and/or substantially parallel to each other, but in other embodiments one or both of the first arm portion 12 and the second arm portion 14 extend at an oblique angle relative to axis y and/or each other. For example, in some embodiments first arm portion 12 is angled relative to axis y in a direction toward the backside B of the clip such that the first arm portion 12 will bear against the insulation layer when installed (as discussed below).

First arm portion 12 has a distal end 12a and a proximal end 12b that terminates at a first bend 13. Second arm portion 14 has a distal end 14a and a proximal end 14b that terminates at a second bend 18. Connecting ledge 16 extends between the first bend 13 and the second bend 18. In some embodiments, the first bend 13 and the second bend 18 are approximately 90° bends such that connecting ledge 16 extends substantially perpendicular to the first arm portion 12 and the second arm portion 14, but such may not always be the case. For example, in some embodiments, first bend 13 may be greater than 90° (but less than) 180° such that the first arm portion 12 is angled toward the backside B of the clip 10. In some embodiments, the first bend 13 is between 90° and 135°, inclusive. The length of the connecting ledge 16 dictates the offset between the first arm portion 12 and second arm portion 14 and may vary depending on the specifics of a particular installation.

A third bend 20 is provided at the distal end 14a of the second arm portion 14 and connects the second arm portion 14 to a retaining arm portion 22. In some embodiments, the third bend 20 is greater than 90° such that the retaining arm portion 22 extends upwardly in a direction toward the proximal end 14b of the second arm portion 14 on the backside B of the clip 10. In some embodiments, the third bend 20 is at least 180°. If the third bend 20 is approximately 180°, the retaining arm portion 22 will extend substantially parallel to the second arm portion 14. While a 180° (or slightly greater) bend has been found to create high static friction fit between installed components, the third bend 20 may be at different angles such that the second arm portion 14 and the retaining arm portion 22 extend at an oblique angle relative to each other.

In some non-limiting embodiments, the retaining arm portion 22 terminates at a retaining arm distal end 22a in a tail portion 24 that extends towards the backside B and at an angle relative to the retaining arm portion 22. In some embodiments, the tail portion 24 extends at an angle of about 45° relative to the retaining arm portion 22. A retention cavity 26 for receiving a portion of a sub-girt is defined between the second arm portion 14 and the retaining arm portion 22. Inclusion of a tail portion 24 increases the size of the cavity opening 26a to help guide the sub-girt into the retention cavity 26.

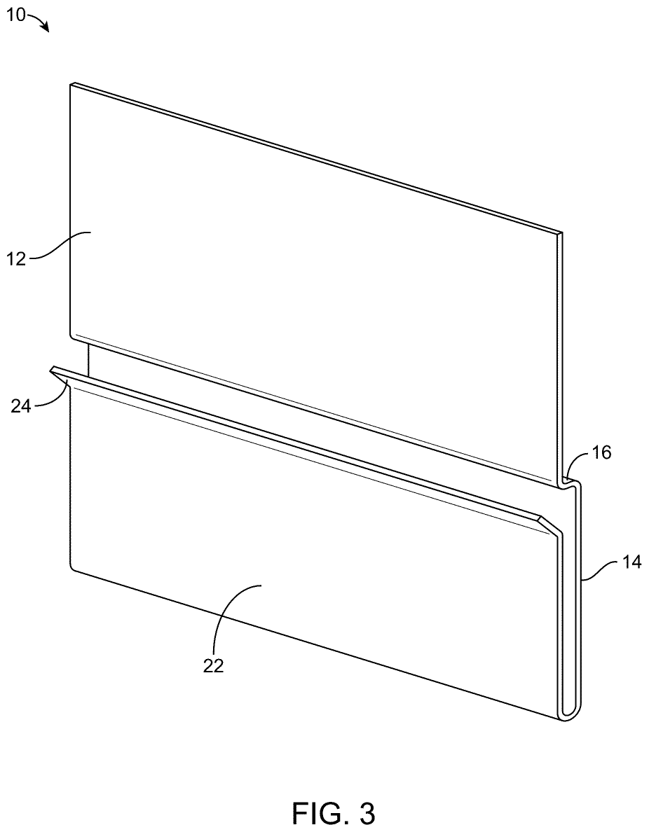

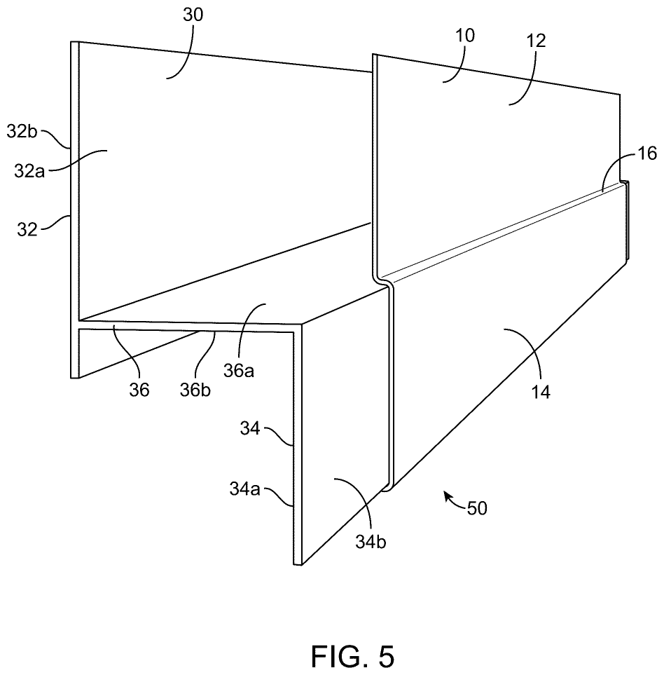

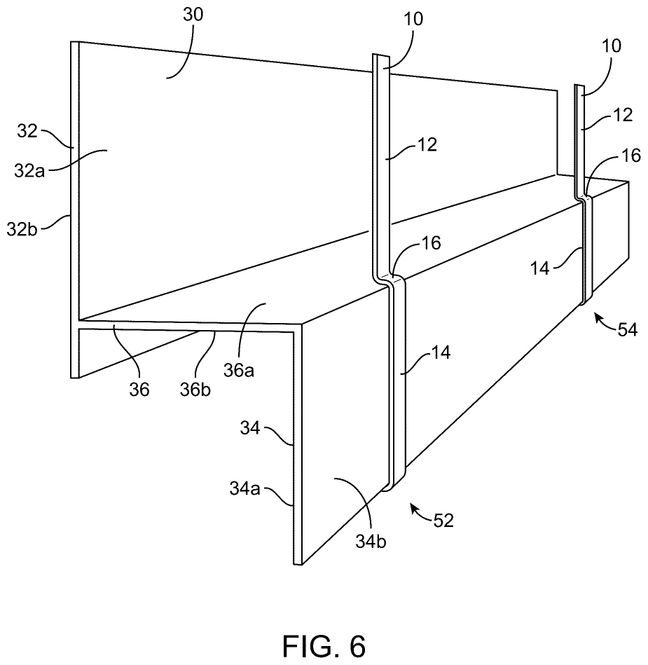

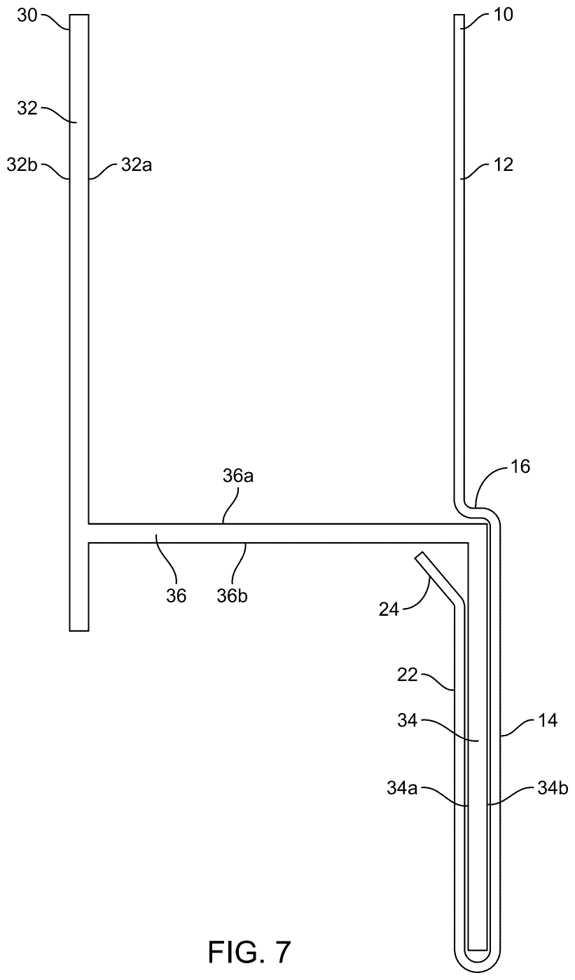

FIG. 5 illustrates the clip of FIGS. 2 and 3 mounted on a support rail or sub-girt 30 at a mounting location 50, and FIG. 6 illustrates the clip 10 of FIG. 4 mounted on a sub-girt 30 at mounting locations 52, 54. FIG. 7 is a side elevation view of the clips 10 installed on sub-girts 30, as shown in FIGS. 5 and 6.

The support rail or sub-girt 30 can be of any length and of a consistent profile that can and often will include a first flange 32 extending in a first direction and having an inner surface 32a and an outer surface 32b and a second flange 34 extending in a second direction opposite the first direction and having an inner surface 34a and an outer surface 34b. The first flange 32 and the second flange 34 are laterally offset from each other by a sub-girt support wall 36 having a first support surface 36a (which may be an upper surface in an installation) and a second support surface 36b (which may be a lower surface in an installation) opposite the first support surface 36a.

The length L of clips 10 used with the sub-girt 30 will typically be equal or less than the length of the sub-girt 30 such that clips 10 can be provided at strategic mounting locations along a sub-girt 30. To install the clip 10 on the sub-girt 30 at a mounting location, the clip 10 may be slid onto the end of the sub-girt 30 and along the length of the sub-girt 30 until it reaches the desired mounting location. In such an embodiment, installation is in a direction parallel to the length of the sub-girt 30.

In another embodiment, the clip 10 is installed in a direction transverse to the length of the sub-girt 30 at the desired mounting location on the sub-girt 30. For example, the clip 10 may be positioned below the sub-girt 30 at the desired mounting location and moved upwardly such that the second flange 34 is received through the cavity opening 26a and within the retention cavity 26. More specifically, the retaining arm portion 22 is able to bend or pivot about the third bend 20 to accept the second flange 34 of the sub-girt 30 within the retention cavity 26 and then spring back to its original position with the second flange 34 of the sub-girt 30 positioned within the retention cavity 26. The clip 10 may then be rotated upwardly so that the connecting ledge 16 of the clip 10 engages the first support surface 36a of the sub-girt support wall 36. In some embodiments, such engagement is a snap-fit engagement.

When a clip 10 is installed on a sub-girt 30 (regardless of the installation methodology) at the desired mounting location, the outer surface 34b of the second flange 34 is entirely covered by the second arm portion 14 of the clip 10 at the mounting location and at least a portion, if not the entirety, of the inner surface 34a of the second flange 34 is covered by the retaining arm portion 22. The second arm portion 14 and the retaining arm portion 22 are then available to receive fasteners, as discussed below.

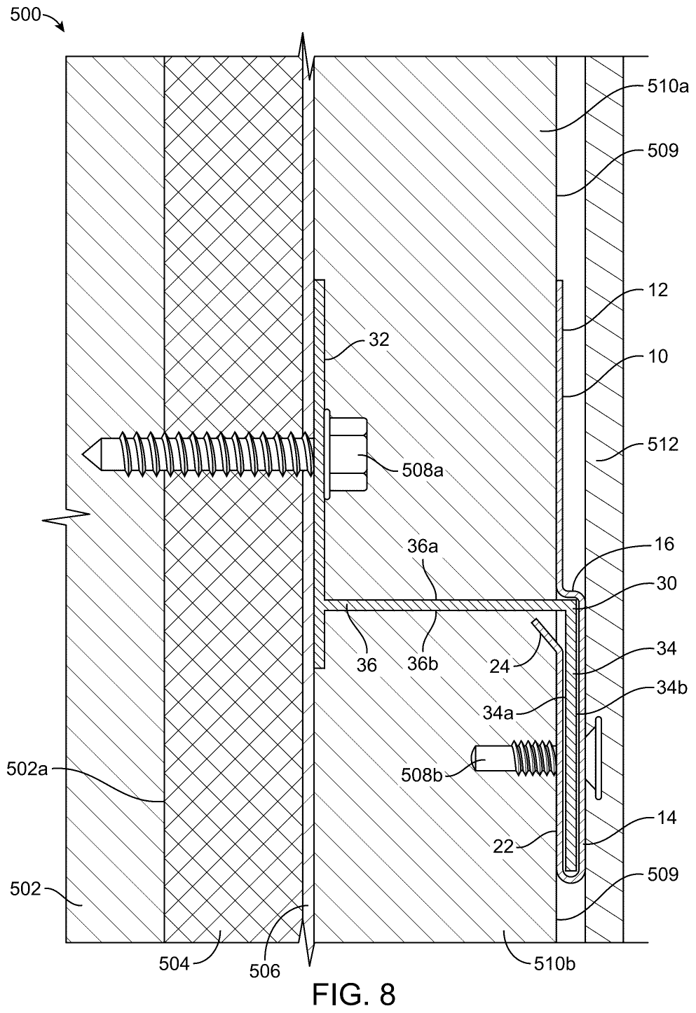

FIG. 8 illustrates clip 10 positioned within an embodiment of an exterior wall system assembly 500. Note that the clips disclosed herein may be used in any interior or exterior wall systems and are not limited for use to the particular assemblies illustrated herein. The exterior wall system assembly 500 comprises a substrate 502 of a building (e.g., framework, stud, etc.) having an outer surface 502a upon which the exterior wall system assembly 500 is installed. A sheathing layer 504 is mounted on the outer surface 502a of the substrate 502. An air and water-resistant barrier 506 is installed on the sheathing layer 504 and can provide a barrier that has the potential to inhibit and/or prevent the inward penetration of air and/or water therethrough to the sheathing layer 504.

A sub-girt 30, such as an FRP sub-girt, is mounted to the sheathing layer 504 and/or substrate 502 by one or more fasteners 508a. More specifically, fasteners 508a extend through the first flange 32 of the sub-girt 30 to retain the sub-girt 30 in place. Clip(s) 10 are provided on the second flange 34 of the sub-girt 30 (as described above) in desired locations along the sub-girt 30. A first (and sometimes upper) insulation layer 510a is mounted adjacent the air and water-resistant barrier 506 and rests upon (or proximate to) the first support surface 36a of the sub-girt support wall 36. The first arm portion 12 of the clip 10 extends adjacent, and may be angled toward, the first insulation layer 510a to help retain the first insulation layer 510a on the sub-girt 30. A second (sometimes lower) insulation layer 510b is positioned on an opposite side of the sub-girt support wall 36 and may engage or rest upon an adjacent sub-girt in the installation. The second flange 34 of the sub-girt 30 extends adjacent the second insulation layer 510b to help retain the second insulation layer 510b within the installation. A cladding panel 512 is mounted within the installation with one or more fasteners 508b that extend through the second flange 34 of sub-girt 30 (as well as the second arm portion 14 and the retaining arm portion 22 of the clip 10). While not shown, fasteners 508b may also be provided through the first arm portion 12 of clip 10. When installed under fasteners 508b, the cladding panel 512 is spaced apart from and aligned generally parallel to the outer faces 509 of the insulation layers 510a, 510b.

Inclusion of clips 10 in the assembly 500 imparts integrity, stability and rigidity to the assembly 500.

Because FRP sub-girts are combustible, they promote flame propagation, especially over openings to the exterior of a building such as windows and doors, and particularly when they are used in combination with a combustible insulation and/or a combustible cladding material. When a combustible cladding is fixed to a FRP sub-girt system, fuel exists on both sides of the ventilation cavity at those locations. Clips 10 may be strategically provided on the FRP sub-girts 30 at such locations of vulnerability within an installation (i.e., proximate windows, doors, etc.) to cover the exposed portions of the combustible FRP sub-girt to eliminate or minimize its combustibility.

Moreover, use of clips 10 in the assembly 500 provides multiple additional attachment flanges (i.e., second arm portion 14 and retaining arm portion 22), and thus additional plies, through which fasteners 508b may extend to increase static and dynamic load capacities and thus help prevent fastener pull-out and pull-over when used in combination with FRP sub-girts. As best seen in FIG. 8, provision of clip 10 around second flange 34 of sub-girt 30 provides an additional attachment structure on both the inner surface 34a and the outer surface 34b of the second flange 34 to help support fastener 508b and fortify and strengthen the connection between the sub-girt 30 and the fastener 508b.

Moreover, the clips 10 are easily installed onto and removed from the sub-girts 30, either by sliding onto the ends of the sub-girts 30 or via snap-fit engagement with the sub-girts 30. As mentioned above, a drawback of FRP sub-girts is that they can become compromised if the installer makes multiple mistakes in the same fastening location. Because the dual attachment flanges (i.e., second arm portion 14 and retaining arm portion 22) of clip 10 provide structural support independent of second flange 34, a ruined clip 10 may be quickly removed and replaced with a new one which spans the destroyed location on the second flange of the FRP sub-girt and provides an undamaged mounting structure for fasteners. The entire FRP sub-girt need not be replaced.

Clip 10 further helps to support static loads within the assembly 500. More specifically, connecting ledge 16 forms a shelf that overlaps a portion of the sub-girt support wall 36 to provide temporary support for such loads. However, the temporary nature of the support becomes permanent and stronger once fasteners 508b are installed. A portion of the load that would otherwise be fully born by the fasteners 508b is transferred to the shelf.

Clip 10 further helps to support and retain insulation layer 510 within the assembly 500 without penetrating the insulation. More specifically and as seen in FIG. 8, first arm 12 of clip 10 abuts and/or bears against the first insulation layer 510a to help retain the first insulation layer 510s on the sub-girt 30 and to ensure that the first insulation layer 510a remains adjacent to the weather barrier 506 to provide the best thermal performance of the insulation without penetrating it.

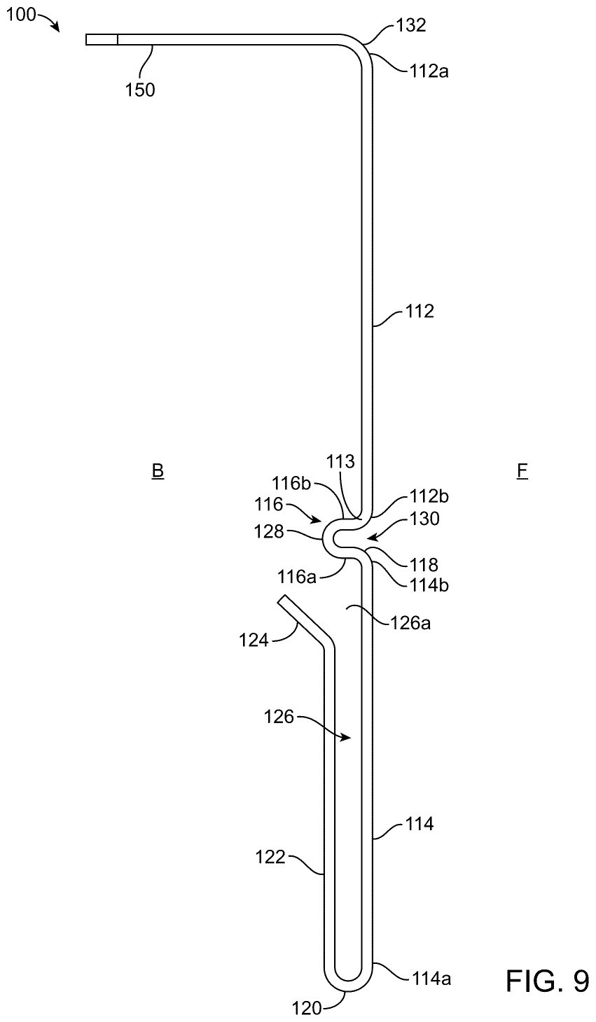

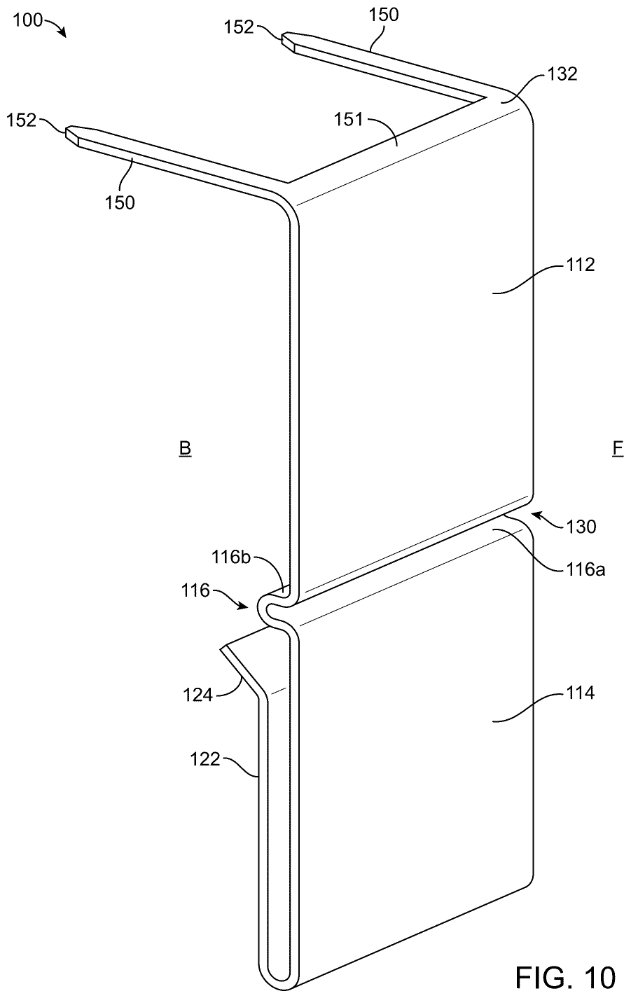

FIGS. 9-11 illustrate another embodiment of a clip 100 for use with sub-girts 30. Clip 100 may be of any length L and is structurally similar to clip 10 in that it includes the same second arm portion 114 (with distal end 114a and proximal end 114b), third bend 120, and retaining arm portion 122 with optional tail portion 124. Retention cavity 126 (with cavity opening 126a) is defined between second arm portion 114 and retaining arm portion 122. Clip 100 also includes first arm portion 112. However, unlike clip 10, first arm portion 112 (with distal end 112a and proximal end 112b) and second arm portion 114 are not connected with a linear connecting ledge 16. Rather, connecting ledge 116 is bent such that it has a first connecting ledge portion 116a and a second connecting ledge portion 116b connected to each other at a fourth bend 128. In some embodiments, the angle of the fourth bend 128 is greater than 90°. In some embodiments, the fourth bend 128 is approximately 180° such that the first connecting ledge portion 116a and the second connecting ledge portion 116b are substantially parallel and separated by a gap 130. Proximal end 114b of second arm portion 114 connects to the first connecting ledge portion 116a at second bend 118 and proximal end 112b of first arm portion 112 connects to the second connecting ledge portion 116b at first bend 113 such that gap 130 is positioned between proximal ends 112b, 114b. In some embodiments and as with clip 10, the angle of first bend 113 and second bend 118 may be approximately 90° such that the first connecting ledge portion 116a and/or the second connecting ledge portion 116b extend substantially perpendicularly to the first arm portion 112 and/or the second arm portion 114. In some embodiments, first connecting ledge portion 116a and second connecting ledge portion 116b are of the same length and/or first arm portion 112 and second arm portion 114 are substantially coplanar, but such may not always be the case. Lateral offset between the first arm portion 112 and the second arm portion 114 may be achieved by adjusting the relative lengths of the first connecting ledge portion 116a and the second connecting ledge portion 116b. As discussed above in connection with clip 10, in some embodiments first arm portion 112 may be angled toward backside B.

One or more insulation pins 150 extend from the distal end 112a of first arm portion 112 toward backside B. In the illustrated embodiment of FIGS. 9-11, two insulation pins 150 spaced a distance from each other extend from the first arm portion 112; however, any number of insulation pins 150 may be provided. In some embodiments, one or more support ledges 151 extend from the distal end 112a of the first arm portion 112 toward backside B and extend between and connect adjacent insulation pins 150. While the insulation pins 150 and support ledge 151 are shown intersecting each other at a 90° angle, the intersection may be at other angles and/or may be curved.

The insulation pins 150 and support ledge 151 are connected to the distal end 112a of the first arm portion 112 by a fifth bend 132. In some embodiments, the angle of the fifth bend 132 is approximately 90° such that the insulation pins 150 and support ledge 151 extend substantially perpendicularly to the first arm portion 112, but other angles of the fifth bend 132 are contemplated. Moreover, insulation pins 150 and/or support ledge 151 can, but may not always, extend at the same angle relative to first arm portion 112. Note that in some embodiments, the clip may include insulation pins 150 and not a support ledge 151, and in other embodiments the clip may include a support ledge(s) 151 and not insulation pins 150.

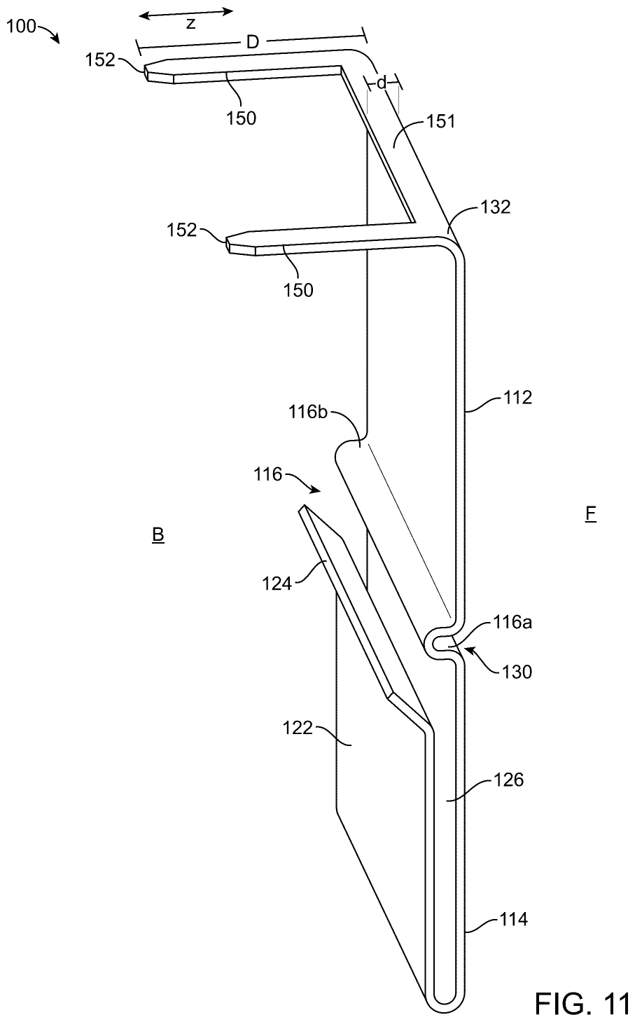

As best seen in FIG. 11, the insulation pins 150 extend to a depth D (measured along axis z) and the support ledge 151 extends to a depth d which is less than depth D. The depth D of each insulation pin 152 may be the same or the insulation pins 152 may extend to different depths D on a clip 100. In some embodiments, the depth D of each insulation pin 150 is between ⅛ inch and 2 inches, inclusive; between ¼ inch and 1.5 inches, inclusive; between ½ inch and 1 inch, inclusive; and/or between ¼ inch and 1 inch, inclusive. In some embodiments and as discussed in more detail below, it may be desirable to limit the depth D of the insulation pins 150 so that they are less than the thickness of the insulation layer. In some embodiments, the insulation pins 150 may have a pointed tip 152, but such may not always be the case.

Note that while not illustrated, one or more insulation pins 150 and/or support ledge 151 could be provided on the clip profile shown in FIG. 1. Provision of one or more insulation pins 150 on clips 10, 100 may be particularly desirable when the clips are for use with vertically mounted sub-girts and insulation where the sub-girt is not supporting the weight of the insulation. In such cases, the insulation pins can help support vertical insulation loads and help prevent the insulation material from moving. Use of insulation pins 150 of different lengths helps to spread out stress within the insulation in a non-linear fashion to increase support.

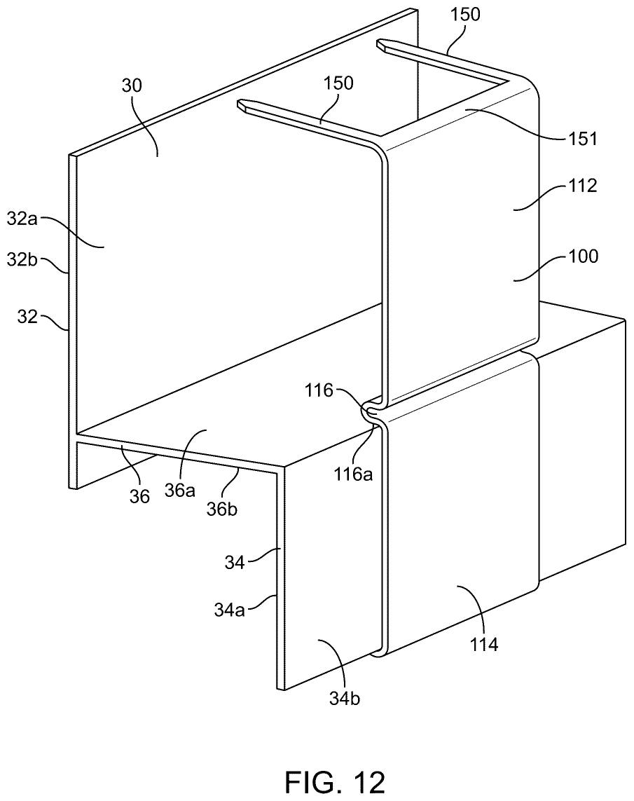

As shown in FIG. 12, clip 100 may be installed on sub-girt 30 in the same manner as clip 10. When so installed, the second flange 34 of the FRP sub-girt 30 is positioned inside of the retention cavity 126 defined between the second arm portion 114 and the retaining arm portion 122 and the first connecting ledge portion 116a engages the first support surface 36a of the sub-girt support wall 36. When a clip 100 is installed on a sub-girt 30 at a mounting location, the outer surface 34b of the second flange 34 is entirely covered by the second arm portion 114 at the mounting location and at least a portion, if not the entirety, of the inner surface 34a of the second flange 34 is covered by the retaining arm portion 122. The second arm portion 114 and the retaining arm portion 122 are then available to receive fasteners, as discussed below.

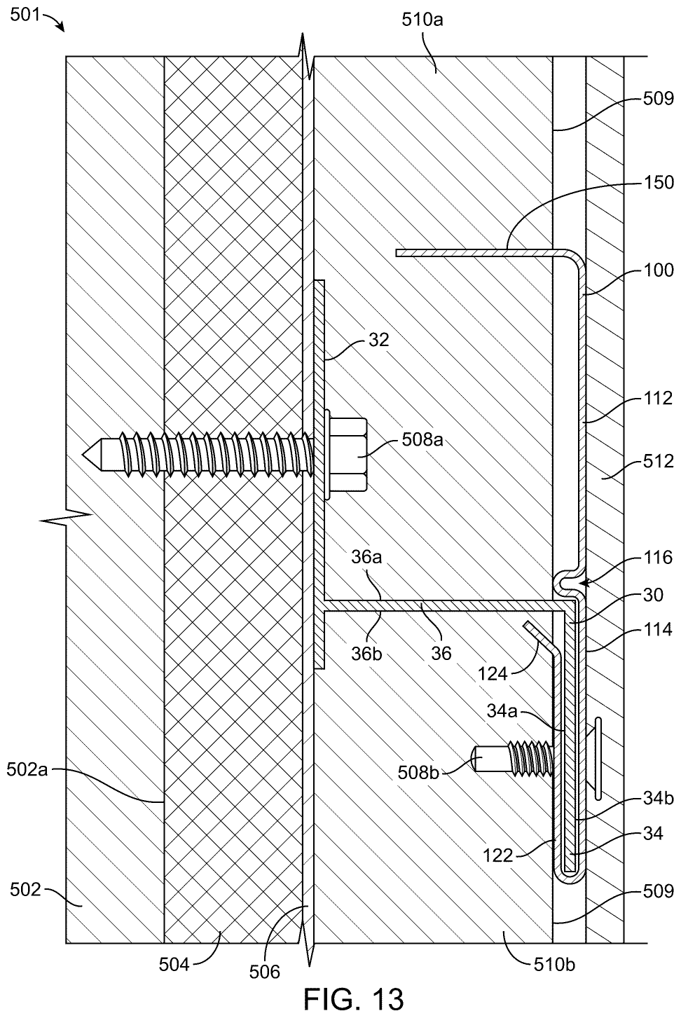

FIG. 13 illustrates clip 100 positioned within an exterior wall system assembly 501. The exterior wall system assembly 500 comprises a substrate 502 of a building (e.g., framework, stud, etc.) having an outer surface 502a upon which the exterior wall system assembly 500 is installed. A sheathing layer 504 is mounted on the outer surface 502a of the substrate 502. An air and water-resistant barrier 506 is installed on the sheathing layer 504 and can provide a barrier that has the potential to inhibit and/or prevent the inward penetration of air and/or water therethrough to the sheathing layer 504.

A sub-girt 30, such as an FRP sub-girt, is mounted to the sheathing layer 504 and/or substrate 502 by one or more fasteners 508a. More specifically, fasteners 508a extend through the first flange 32 of the sub-girt 30 to retain the sub-girt 30 in place. Clips 100 are provided on the second flange 34 of the sub-girt 30 (as described above) in desired locations along the sub-girt 30. A first (and sometimes upper) insulation layer 510a is mounted adjacent the air and water-resistant barrier 506 and rests upon (or proximate to) the first support surface 36a of the sub-girt support wall 36. The first arm portion 112 of the clip 10 extends adjacent, and may be angled toward, the first insulation layer 510a. Insulation pins 150 extend into the first insulation layer 510a and support ledge 151 bears against the insulation layer 510a to help retain the first insulation layer 510a on the sub-girt 30. As evident in FIG. 13, the depth D of the insulation pins 150 is less than the thickness of the insulation layer 510a. In this way, when first arm portion 112 abuts the outer face 509 of insulation layer 510a, the insulation pins 150 are spaced a distance from the air and water-resistant barrier 506. This spacing ensures that the insulation pins 150 cannot pierce the air and water-resistant barrier 506 (which can lead to leaks in the assembly) and will not provide thermal and acoustic bridging to the building substrate 502.

A second (sometimes lower) insulation layer 510b is positioned on an opposite side of the sub-girt support wall 36 and may engage or rest upon an adjacent sub-girt in the installation. The second flange 34 of the sub-girt 30 extends adjacent the second insulation layer 510b to help retain the second insulation layer 510b within the installation. A cladding panel 512 is mounted within the installation with one or more fasteners 508b that extend through the second flange 34 of sub-girt 30 (as well as the second arm portion 114 and the retaining arm portion 122 of the clip 100). While not shown, fasteners 508b may also be provided through the first arm portion 112 of clip 100. When installed on fasteners 508b, the cladding panel 512 is spaced apart from and aligned generally parallel to the outer faces 509 of the insulation layers 510a, 510b.

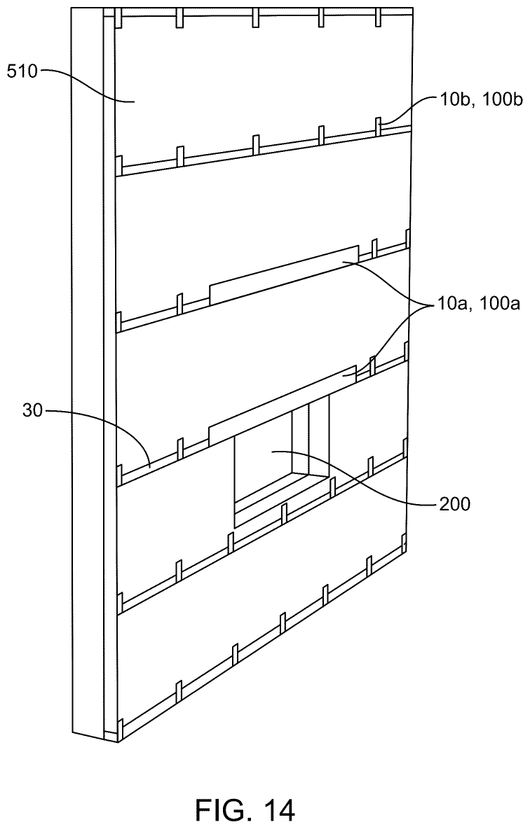

FIG. 14 schematically represents a possible layout for clips 10, 100 within an installation. Note that the cladding has not been installed in the installation so that clip placement is visible. Clips of a longer length L (see, e.g., FIGS. 2 and 3) are particularly well-suited for installation proximate combustible openings, such as windows, doors, etc., through which flames are likely to pass during a fire. In FIG. 14, longer clip 10a, 100a are positioned on sub-girts 30 so as to span an upper edge of a window opening 200. As shown in FIG. 14, longer clips 10a, 100a may extend across more than one sub-girt 30 above the window opening 200. During a fire, the combustible FRP sub-girt 30 will melt long before the longer clips 10a, 100a. Longer clips 10a, 100a will trap the melted polymer of the FRP sub-girt to which they were mounted and help prevent the melted polymer from dripping from the installation. Longer clips 10a, 100a maintain a bridge across the opening created by the melted FRP sub-girt 30 and continue to support the cladding via fasteners. It will be obvious to one of skill in the art that the length of the longer clips 10a, 100b can be customized to any desired length suitable to span an opening within an installation.

In locations more distal such openings 200 where combustibility is not as much of a concern, clips 10, 100 of a shorter length L (e.g., shorter clips 10b, 100b) may be provided for insulation support and cladding fastening, as described above.

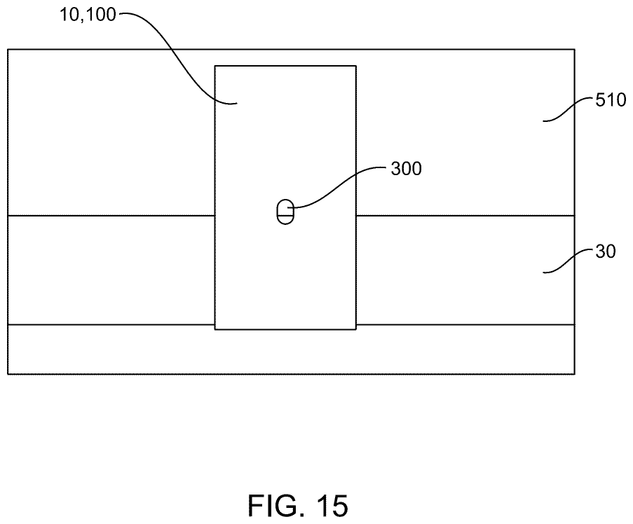

As shown in FIG. 15, one or more drainage holes 300 may be provided at desired locations on clips 10, 100 to permit water and moisture to drain from the assembly.

Any additions, modifications or permutations which may be made to steel studs and purlins which increase strengths and/or use of thinner steel such as stamped dimples, indentations, punched holes with flanges, additional flanges, etc., may be used to increase the structural strengths of the clips disclosed herein. Moreover, any surface of the clips may be used to attach other components such as insulation struts and/or coatings such as intumescent coatings for the purpose of greater support of insulations or for better fire control.

The clip arms have been shown with smooth planar surfaces, but they may be contoured and/or provided with surface textures or other enhancements as desired. Adhesives and/or coatings may be added anywhere in or on the clips for the purpose of bonding and increasing strengths, increasing or altering visual aesthetics via color or texture, to increase thermal and acoustic performance, to act as a fire block or retardant with an intumescent strip or paint, or any other commonly known purpose. As an example, a rubberized coating such as Rhino or Linex may be applied in a sputtering process to the surface of the clip to prevent slipping of the cladding or it's attachment material during mechanical fastening; to provide an alternative to glass beads to dictate a certain thickness of adhesive to be applied; to limit or prevent galvanic corrosion between dis-similar materials; and/or to minimize or prevent a phenomenon called ‘ghosting’, which is visible condensation on the exterior of the cladding due to thermal bridging from the cladding's sub-framing components.

### EXAMPLES

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

Example 1. An integrally formed, fire-resistant clip having a frontside and a backside and adapted to engage and partially cover a support rail within a building assembly, the clip comprising a first arm portion having a distal end and a proximal end; a second arm portion having a distal end and a proximal end; a connecting ledge connecting the proximal end of the first arm portion to the proximal end of the second arm portion, wherein the connecting ledge is connected to the proximal end of the first arm portion at a first bend and to the proximal end of the second arm portion at a second bend and wherein the connecting ledge extends at an angle to each of the first arm portion and the second arm portion; and a retaining arm portion connected to the distal end of the second arm portion at a third bend, wherein the third bend is greater than 90° such that the retaining arm portion extends in a direction toward the proximal end of the second arm portion on the backside of the clip and such that a retention cavity is defined between the retaining arm portion and the second arm portion.

Example 2. The clip of any of the preceding or subsequent examples or combination of examples, wherein the first bend is between 90° and 135°, inclusive.

Example 3. The clip of any of the preceding or subsequent examples or combination of examples, wherein the second bend is approximately 90°.

Example 4. The clip of any of the preceding or subsequent examples or combination of examples, wherein the first arm portion and the second arm portion are laterally offset from each other by the connecting ledge.

Example 5. The clip of any of the preceding or subsequent examples or combination of examples, wherein the connecting ledge comprises a direct linear connection between the first bend and the second bend.

Example 6. The clip of any of the preceding or subsequent examples or combination of examples, wherein the connecting ledge comprises a first connecting ledge portion connected to the proximal end of the second arm portion at the second bend and a second connecting ledge portion connected to the proximal end of the first arm portion at the first bend, wherein the first connecting ledge portion and the second connecting ledge portion are connected at a fourth bend.

Example 7. The clip of any of the preceding or subsequent examples or combination of examples, wherein the fourth bend is approximately 180° such that the first connecting ledge portion and the second connecting ledge portion are substantially parallel and separated by a gap.

Example 8. The clip of any of the preceding or subsequent examples or combination of examples, wherein the third bend is approximately 180° such that the retaining arm portion extends substantially parallel to the second arm portion.

Example 9. The clip of any of the preceding or subsequent examples or combination of examples, wherein the retaining arm portion extends at an oblique angle relative to the second arm portion.

Example 10. The clip of any of the preceding or subsequent examples or combination of examples, wherein the retaining arm portion comprises a distal end and wherein a tail portion extends towards the backside of the clip and at an angle to the retaining arm portion.

Example 11. The clip of any of the preceding or subsequent examples or combination of examples, further comprising at least one pin extending from the distal end of the first arm portion and toward the backside of the clip.

Example 12. The clip of any of the preceding or subsequent examples or combination of examples, wherein the at least one pin comprises a pointed tip.

Example 13. The clip of any of the preceding or subsequent examples or combination of examples, wherein the clip is formed of metal.

Example 14. A wall system assembly comprising a support rail having a length and formed of a fiber reinforced polymer, the support rail comprising a first flange extending in a first direction and having an inner surface and an outer surface; a second flange extending in a second direction opposite the first direction and having an inner surface and an outer surface; and a support wall having a first support surface and an opposing second support surface and connecting the first flange and the second flange such that the first flange and the second flange are laterally offset from each other; and an integrally formed, fire-resistant clip having a frontside and a backside and comprising a first arm portion having a distal end and a proximal end; a second arm portion having a distal end and a proximal end; a connecting ledge connecting the proximal end of the first arm portion to the proximal end of the second arm portion, wherein the connecting ledge is connected to the proximal end of the first arm portion at a first bend and to the proximal end of the second arm portion at a second bend and wherein the connecting ledge extends at an angle to each of the first arm portion and the second arm portion; and a retaining arm portion connected to the distal end of the second arm portion at a third bend, wherein the third bend is greater than 90° such that the retaining arm portion extends in a direction toward the proximal end of the second arm portion on the backside of the clip and such that a retention cavity is defined between the retaining arm portion and the second arm portion, wherein the clip is mounted on the support rail at a mounting location along the length of the support rail such that the second flange of the support rail resides in the retention cavity of the clip and such that the connecting ledge of the clip seats on the first support surface of the support rail and wherein, at the mounting location, the second arm portion of the clip covers the entirety of the outer surface of the second flange, the retaining arm portion of the clip covers at least a portion of the inner surface of the second flange, and the first arm portion extends away from the support wall in the first direction.

Example 15. The wall system assembly of any of the preceding or subsequent examples or combination of examples, further comprising a building substrate, wherein the first flange of the support rail is attached to the building substrate.

Example 16. The wall system assembly of any of the preceding or subsequent examples or combination of examples, further comprising at least one fastener that extends through the second arm portion of the clip, the second flange of the support rail, and the retaining arm portion of the clip.

Example 17. The wall system assembly of any of the preceding or subsequent examples or combination of examples, further comprising a panel supported by the at least one fastener.

Example 18. The wall system assembly of any of the preceding or subsequent examples or combination of examples, wherein the building substrate defines an opening having an upper edge and wherein the clip extends proximate the upper edge of the opening.

Example 19. The wall system assembly of any of the preceding or subsequent examples or combination of examples, further comprising an insulation layer having an inner face, an outer face and a thickness defined between the inner face and the outer face, wherein the insulation layer is positioned adjacent the first support surface of the support wall and wherein the first arm portion of the clip extends along at least a portion of the outer face of the insulation layer.

Example 20. The wall system assembly of any of the preceding or subsequent examples or combination of examples, wherein the clip further comprises at least one pin extending from the distal end of the first arm portion and toward the backside of the clip, wherein the at least one pin comprises a depth that is less than the thickness of the insulation layer such that and wherein the at least one pin extends through the outer face of the insulation layer and into the insulation layer but does not extend through the inner face of the insulation layer.

Example 21. The wall system assembly of any of the preceding or subsequent examples or combination of examples, wherein the clip is adapted to mount on the support rail via snap-fit engagement.

Example 22. The wall system assembly of any of the preceding or subsequent examples or combination of examples, wherein the clip is adapted to mount on the support rail by sliding onto an end of the support rail.

Example 23. An integrally formed metal clip having a frontside and a backside and comprising a first arm portion having a distal end and a proximal end; a second arm portion having a distal end and a proximal end; a connecting ledge connecting the proximal end of the first arm portion to the proximal end of the second arm portion, wherein the connecting ledge is connected to the proximal end of the first arm portion at a first bend between 90° and 135°, inclusive, and to the proximal end of the second arm portion at a second bend of approximately 90° and wherein the connecting ledge extends at an angle to each of the first arm portion and the second arm portion; and a retaining arm portion connected to the distal end of the second arm portion at a third bend, wherein the third bend is approximately 180° such that the retaining arm portion extends substantially parallel to the second arm portion on the backside of the clip and such that a retention cavity is defined between the retaining arm portion and the second arm portion.

The various aspects, embodiments, implementations or features of the described embodiments can be used separately or in any combination. In particular, it should be appreciated that the various elements of concepts from FIGS. 1-15 may be combined without departing from the spirit or scope of the invention.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description.

The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

We claim:

1. An integrally formed, fire-resistant clip having a frontside and a backside and adapted to engage and partially cover a support rail within a building assembly, the clip comprising:
a. a first arm portion having a distal end and a proximal end;
b. a second arm portion having a distal end and a proximal end;
c. a connecting ledge connecting the proximal end of the first arm portion to the proximal end of the second arm portion, wherein the connecting ledge is connected to the proximal end of the first arm portion at a first bend and to the proximal end of the second arm portion at a second bend and wherein the connecting ledge extends at an angle to each of the first arm portion and the second arm portion; and
d. a retaining arm portion connected to the distal end of the second arm portion at a third bend, wherein the third bend is greater than 90° such that the retaining arm portion extends in a direction toward the proximal end of the second arm portion on the backside of the clip and such that a retention cavity is defined between the retaining arm portion and the second arm portion.

2. The clip of claim 1, wherein the first bend is between 90° and 135°, inclusive.

3. The clip of claim 1, wherein the second bend is approximately 90°.

4. The clip of claim 1, wherein the first arm portion and the second arm portion are laterally offset from each other by the connecting ledge.

5. The clip of claim 1, wherein the connecting ledge comprises a direct linear connection between the first bend and the second bend.

6. The clip of claim 1, wherein the connecting ledge comprises a first connecting ledge portion connected to the proximal end of the second arm portion at the second bend and a second connecting ledge portion connected to the proximal end of the first arm portion at the first bend, wherein the first connecting ledge portion and the second connecting ledge portion are connected at a fourth bend.

7. The clip of claim 6, wherein the fourth bend is approximately 180° such that the first connecting ledge portion and the second connecting ledge portion are substantially parallel and separated by a gap.

8. The clip of claim 1, wherein the third bend is approximately 180° such that the retaining arm portion extends substantially parallel to the second arm portion.

9. The clip of claim 1, wherein the retaining arm portion extends at an oblique angle relative to the second arm portion.

10. The clip of claim 1, wherein the retaining arm portion comprises a distal end and wherein a tail portion extends towards the backside of the clip and at an angle to the retaining arm portion.

11. The clip of claim 1, further comprising at least one pin extending from the distal end of the first arm portion and toward the backside of the clip.

12. A wall system assembly comprising:
a. a support rail having a length and formed of a fiber reinforced polymer, the support rail comprising:
i. a first flange extending in a first direction and having an inner surface and an outer surface;
ii. a second flange extending in a second direction opposite the first direction and having an inner surface and an outer surface; and
iii. a support wall having a first support surface and an opposing second support surface and connecting the first flange and the second flange such that the first flange and the second flange are laterally offset from each other; and
b. an integrally formed, fire-resistant clip having a frontside and a backside and comprising:
i. a first arm portion having a distal end and a proximal end;
ii. a second arm portion having a distal end and a proximal end;
iii. a connecting ledge connecting the proximal end of the first arm portion to the proximal end of the second arm portion, wherein the connecting ledge is connected to the proximal end of the first arm portion at a first bend and to the proximal end of the second arm portion at a second bend and wherein the connecting ledge extends at an angle to each of the first arm portion and the second arm portion; and
iv. a retaining arm portion connected to the distal end of the second arm portion at a third bend, wherein the third bend is greater than 90° such that the retaining arm portion extends in a direction toward the proximal end of the second arm portion on the backside of the clip and such that a retention cavity is defined between the retaining arm portion and the second arm portion,
wherein the clip is mounted on the support rail at a mounting location along the length of the support rail such that the second flange of the support rail resides in the retention cavity of the clip and such that the connecting ledge of the clip seats on the first support surface of the support rail and wherein, at the mounting location, the second arm portion of the clip covers the entirety of the outer surface of the second flange, the retaining arm portion of the clip covers at least a portion of the inner surface of the second flange, and the first arm portion extends away from the support wall in the first direction.

13. The wall system assembly of claim 12, further comprising a building substrate, wherein the first flange of the support rail is attached to the building substrate.

14. The wall system assembly of claim 13, further comprising at least one fastener that extends through the second arm portion of the clip, the second flange of the support rail, and the retaining arm portion of the clip.

15. The wall system assembly of claim 13, wherein the building substrate defines an opening having an upper edge and wherein the clip extends proximate the upper edge of the opening.

16. The wall system assembly of claim 12, further comprising an insulation layer having an inner face, an outer face and a thickness defined between the inner face and the outer face, wherein the insulation layer is positioned adjacent the first support surface of the support wall and wherein the first arm portion of the clip extends along at least a portion of the outer face of the insulation layer.

17. The wall system assembly of claim 16, wherein the clip further comprises at least one pin extending from the distal end of the first arm portion and toward the backside of the clip, wherein the at least one pin comprises a depth that is less than the thickness of the insulation layer such that and wherein the at least one pin extends through the outer face of the insulation layer and into the insulation layer but does not extend through the inner face of the insulation layer.

18. The wall system assembly of claim 12, wherein the clip is adapted to mount on the support rail via snap-fit engagement.

19. The wall system assembly of claim 12, wherein the clip is adapted to mount on the support rail by sliding onto an end of the support rail.

20. An integrally formed metal clip having a frontside and a backside and comprising:
a. a first arm portion having a distal end and a proximal end;
b. a second arm portion having a distal end and a proximal end;
c. a connecting ledge connecting the proximal end of the first arm portion to the proximal end of the second arm portion, wherein the connecting ledge is connected to the proximal end of the first arm portion at a first bend between 90° and 135°, inclusive, and to the proximal end of the second arm portion at a second bend of approximately 90° and wherein the connecting ledge extends at an angle to each of the first arm portion and the second arm portion; and
d. a retaining arm portion connected to the distal end of the second arm portion at a third bend, wherein the third bend is approximately 180° such that the retaining arm portion extends substantially parallel to the second arm portion on the backside of the clip and such that a retention cavity is defined between the retaining arm portion and the second arm portion.
